(19) United States
(12) Patent Application Publication
(10) Pub. No.: US 2015/0337569 A1
(43) Pub. Date: Nov. 26, 2015

(54) DEVICE FOR OPENING AND CLOSING PUSH OPEN TYPE FUEL DOOR FOR VEHICLE

(71) Applicants: Hyundai Motor Company, Seoul (KR); Kia Motors Corporation, Seoul (KR); Costech Inc., Gunsan-si (KR)

(72) Inventors: Sang Kyoon LIM, Bucheon-Si (KR); Na Eon KIM, Goyang-Si (KR); Sung Ki LEE, Iksan-Si (KR); Kyung Hoon PARK, Suwon-Si (KR)

(73) Assignees: Hyundai Motor Company, Seoul (KR); Kia Motors Corporation, Seoul (KR)

(21) Appl. No.: 14/570,223

(22) Filed: Dec. 15, 2014

(30) Foreign Application Priority Data
May 22, 2014 (KR) 10-2014-0061711

(51) Int. Cl. E05B 83/34

(52) U.S. Cl. CPC E05B 83/34

(57) ABSTRACT

A device for opening and closing a push open type fuel door for a vehicle may include a latch assembly, a push button assembly and a motor assembly modularized and mounted in a single housing. The latch assembly may come into direct contact with a fuel door so as to lock or unlock the fuel door. The push button assembly may be connected with the latch assembly so as to be operated in conjunction with the latch assembly, and unlock or lock the latch assembly while being moved upward or downward by pushing the fuel door. The motor assembly may lock a push button of the push button assembly so as to restrict movement of the push button and the latch assembly when the fuel door is closed.

### CROSS-REFERENCE TO RELATED APPLICATION

The present application claims priority of Korean Patent Application Number 10-2014-0061711 filed on May 22, 2014, the entire contents of which application are incorporated herein for all purposes by this reference.

### BACKGROUND OF INVENTION

1. Field of Invention

The present disclosure relates to a device for opening and closing a push open fuel door for a vehicle. More particularly, it relates to a device for opening and closing a push open fuel door for a vehicle, which opens and closes the fuel door by a one touch push operation.

2. Description of Related Art

In general, an operation of opening a fuel door for a vehicle is performed by manipulating a switch, which is installed at the periphery of a driver seat, to an opening position.

Recently, for the purpose of convenience of self-service refueling, a push open type fuel door, which may be opened and closed by a one touch push operation without operating a separate switch, is applied. The attached FIGS. 1 and 2 are cross-sectional views illustrating a device for opening and closing a push open type fuel door in the related art.

In FIGS. 1 and 2, reference numeral 10 indicates a fuel door. A push button 12 is mounted on a refueling port peripheral panel that is positioned inside the fuel door 10, and an electric locking catch 14 is mounted at a peripheral position of the push button 12. The locking catch 14 is inserted into or separated from a locking groove 16, which is formed in an inner surface of the fuel door 10, by an electrical signal.

Therefore, when a user pushes the fuel door 10 in a state in which the locking catch 14 is separated from the locking groove 16, the push button 12 is pushed and simultaneously protrudes to push the fuel door 10, such that the fuel door is opened. In contrast, when the user pushes the fuel door 10 in a closing direction, the push button 12 is pressed, the fuel door 10 is closed, and the locking catch 14 is inserted and locked into the locking groove 16.

However, since the push button and the locking catch of the push open type fuel door in the related art are configured as separate components, the number of sub components required is large, and the number of assembly processes is increased. Since the push button may be separately operated in a locked state by the locking catch, there occurs a malfunction in which the locking catch is unlocked in a state in which the fuel door slightly pops up as the push button is pressed, and the fuel door pops up rapidly.

The information disclosed in this Background section is only for enhancement of understanding of the general background of the invention and should not be taken as an acknowledgement or any form of suggestion that this information forms the prior art already known to a person skilled in the art.

### SUMMARY OF INVENTION

The present invention has been made in an effort to solve the above-described problems associated with the prior art and/or other problems, and the present invention is to provide a device for opening and closing a push open type fuel door in which a latch assembly and a push button assembly, which may open and close a fuel door by a one touch push operation without a pop-up phenomenon, and a motor assembly, which may lock a push button of the push button assembly so that the push button is not moved when the fuel door is closed, are modularized as a single component.

In various aspects, the present invention provides a device for opening and closing a push open type fuel door for a vehicle, the device including: a latch assembly which comes into direct contact with a fuel door so as to lock or unlock the fuel door; a push button assembly which is connected with the latch assembly so as to be operated in conjunction with the latch assembly, and unlocks or locks the latch assembly while being moved upward or downward by pushing the fuel door; and a motor assembly which locks a push button of the push button assembly so as to restrict movement of the push button and the latch assembly when the fuel door is closed, wherein the latch assembly, the push button assembly and the motor assembly are modularized and mounted in a single housing.

In an aspect, the latch assembly may include: a striker which is formed on a rear surface of the fuel door; a latch including a first locking groove into which the striker is separably inserted and locked and a catching projection which is caught by an upper end portion of a vertical chamber of the housing, wherein the first locking groove is formed in one surface of the latch, and the catching projection is formed on a lower end portion of another surface of the latch and hingedly fastened to an upper end portion of the push button of the push button assembly; and a return spring which is fastened to a point at which the latch is hingedly fastened to the push button, and provides elastic restoring force so as to guide the latch in a direction in which the striker is separated.

In another aspect, the push button assembly may include: a fixed tube including a first open hole formed in a lower end portion at one side and a stepped portion formed at a middle portion, and fixedly mounted in the vertical chamber of the housing; the push button having a tube shape and disposed on an outer diameter portion of the fixed tube so as to be movable upward and downward, wherein a latch of the latch assembly is hingedly fastened to an upper end portion of the push button, and the push button has a second open hole formed in a lower end portion at one side of the push button and matched with the first open hole of the fixed tube; a main spring which is compressibly disposed between a bottom surface of the push button and the stepped portion of the fixed tube; and a stopper means which is mounted in the fixed tube so as to allow the push button to be moved upward and downward when the fuel door is opened, and temporarily stop the upward and downward movement of the push button when the fuel door is closed.

In still another aspect, the stopper means may include: a heart cam including flat upper and lower surfaces and recessed left and right surfaces, and hingedly mounted in the fixed tube so as to protrude through the first open hole of the fixed tube when the heart cam is horizontally or diagonally disposed, or to be rotated to be disposed in the first open hole when the heart cam is vertically disposed; an auxiliary spring which is inserted into an insertion groove formed in a bottom surface of the fixed tube; and a ball which is integrally attached to an upper end of the auxiliary spring, and comes into close contact with a surface of the heart cam while receiving elastic force of the auxiliary spring.

In yet another aspect the motor assembly includes: a motor which is mounted in a horizontal chamber that communicates with the vertical chamber of the housing; a conveying body which is fastened to a screw shaft of the motor so as to be movable forward and rearward; and a locking pin which protrudes on a front end portion of the conveying body, and is separably inserted into a second locking groove formed in an outer diameter surface of the push button of the push button assembly.

Through the technical solutions disclosed herein, the present invention provides the effects below.

Firstly, the latch assembly and the push button assembly, which may open and close the fuel door using a one touch push operation, and the motor assembly, which locks the push button of the push button assembly and the latch of the latch assembly when the fuel door is closed so that the push button and the latch are not moved, are modularized as a single component, thereby reducing the number of assembly processes, and improving assembly workability.

Secondly, a speed at which the fuel door pops up in an opening direction may be constantly controlled when the push button of the push button assembly is moved upward and downward, and the push button of the push button assembly and the latch of the latch assembly are not moved by a locking operation of the motor assembly when the fuel door is closed, thereby preventing a pop-up phenomenon in which the fuel door is slightly opened when the fuel door is closed.

Other aspects and preferred embodiments of the invention are discussed infra.

It is understood that the term “vehicle” or “vehicular” or other similar terms as used herein is inclusive of motor vehicles in general such as passenger automobiles including sports utility vehicles (SUV), buses, trucks, various commercial vehicles, watercraft including a variety of boats and ships, aircraft, and the like, and includes hybrid vehicles, electric vehicles, plug-in hybrid electric vehicles, hydrogen-powered vehicles and other alternative fuel vehicles (e.g., fuel derived from resources other than petroleum). As referred to herein, a hybrid vehicle is a vehicle that has two or more sources of power, for example, both gasoline-powered and electric-powered vehicles.

The above and other features of the invention are discussed infra.

The methods and apparatuses of the present invention have other features and advantages which will be apparent from or are set forth in more detail in the accompanying drawings, which are incorporated herein, and the following Detailed Description, which together serve to explain certain principles of the present invention.

### BRIEF DESCRIPTION OF THE DRAWINGS

The above and other features of the present invention will now be described in detail with reference to certain exemplary embodiments thereof illustrated in the accompanying drawings which are given hereinbelow by way of illustration only, and thus are not limitative of the present invention, and wherein:

FIGS. 1A, 1B and 2 are cross-sectional views illustrating a device for opening and closing a push open type fuel door in the related art;

FIG. 3 is a cross-sectional view illustrating an exemplary device for opening and closing a push open type fuel door according to the present invention;

FIGS. 4A, 4B, 4C, 4D, 4E, 4F, 4G and 4H are views or cross-sectional views illustrating a flow of opening and closing operations of the device for opening and closing the push open type fuel door according to the present invention; and

FIGS. 5A and 5B are views illustrating a state in which a motor assembly of the device for opening and closing the push open type fuel door according to the present invention locks the fuel door.

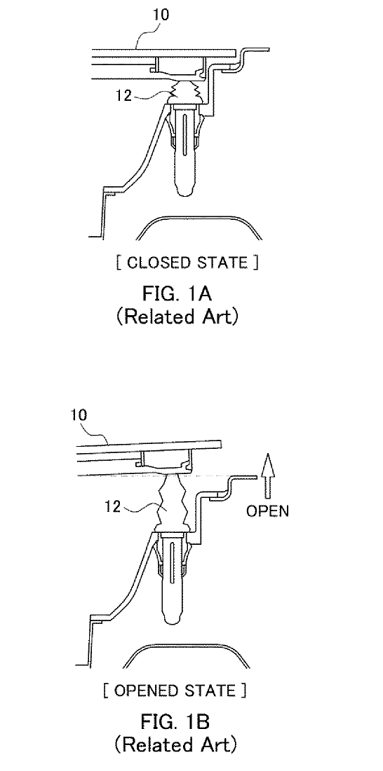

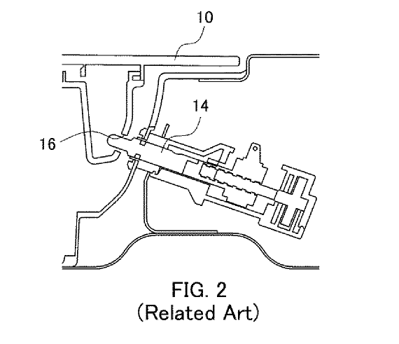

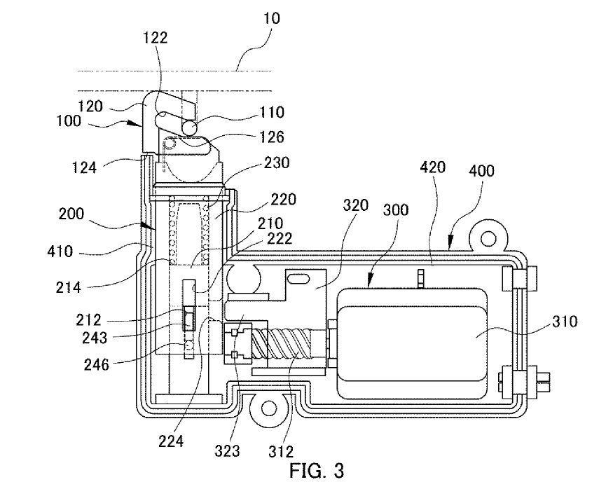

Reference numerals set forth in the Drawings include reference to the following elements as further discussed below:

| | |
|---|---|
| 10: fuel door | 100: latch assembly |
| 110: striker | 120: latch |
| 122: first locking groove | 124: catching projection |

| | |
|---|---|
| 126: return spring | 200: push button assembly |

| | |
|---|---|
| 210: fixed tube | 212: first open hole |
| 214: stepped portion | 220: push button |
| 222: second open hole | 224: second locking groove |
| 230: main spring | 240: stopper means |
| 241: flat surface | 242: recess |
| 243: heart cam | 244: insertion groove |
| 245: auxiliary spring | 246: ball |
| 300: motor assembly | 310: motor |
| 312: screw shaft | 320: conveying body |
| 323: locking pin | 400: housing |
| 410: vertical chamber | 420: horizontal chamber |

It should be understood that the appended drawings are not necessarily to scale, presenting a somewhat simplified representation of various preferred features illustrative of the basic principles of the invention. The specific design features of the present invention as disclosed herein, including, for example, specific dimensions, orientations, locations, and shapes will be determined in part by the particular intended application and use environment.

In the figures, reference numbers refer to the same or equivalent parts of the present invention throughout the several figures of the drawing.

### DETAILED DESCRIPTION

Reference will now be made in detail to various embodiments of the present invention(s), examples of which are illustrated in the accompanying drawings and described below. While the invention(s) will be described in conjunction with exemplary embodiments, it will be understood that present description is not intended to limit the invention(s) to those exemplary embodiments. On the contrary, the invention(s) is/are intended to cover not only the exemplary embodiments, but also various alternatives, modifications, equivalents and other embodiments, which may be included within the spirit and scope of the invention as defined by the appended claims.

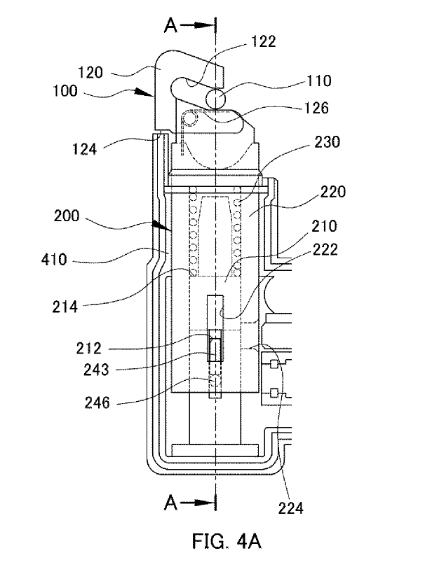

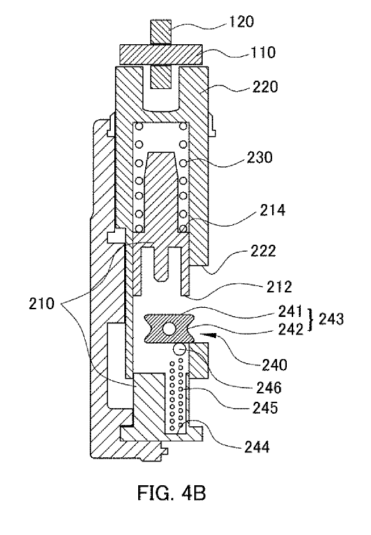

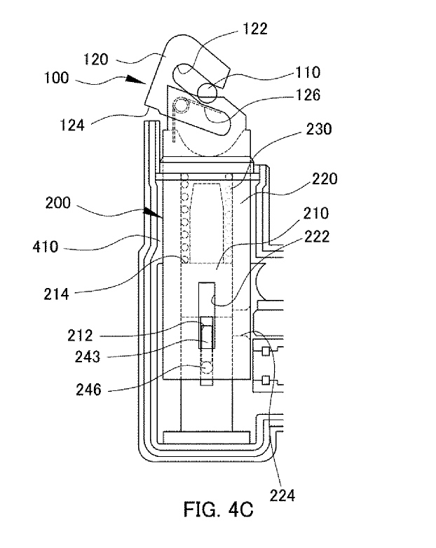

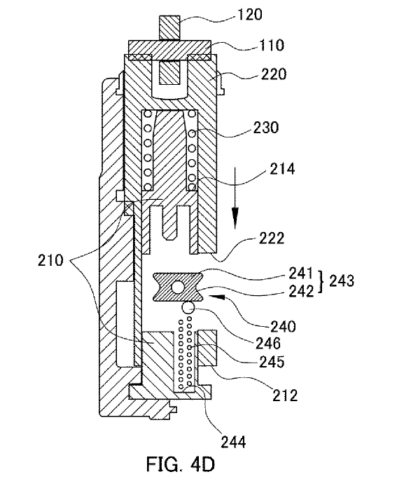

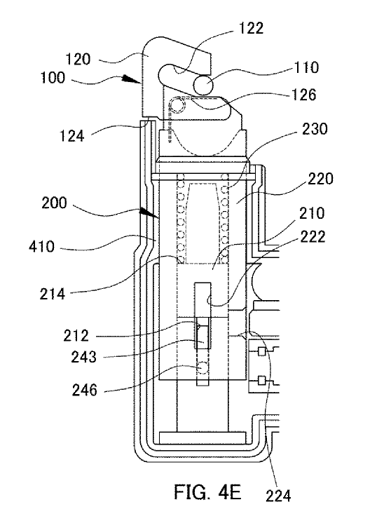

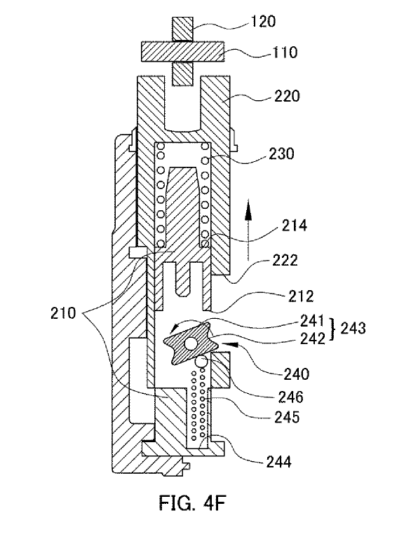

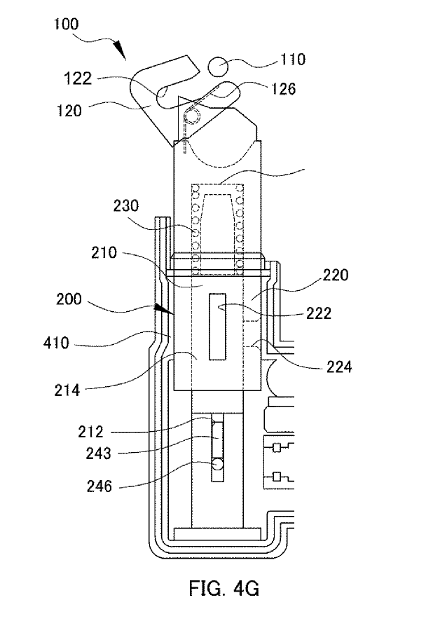

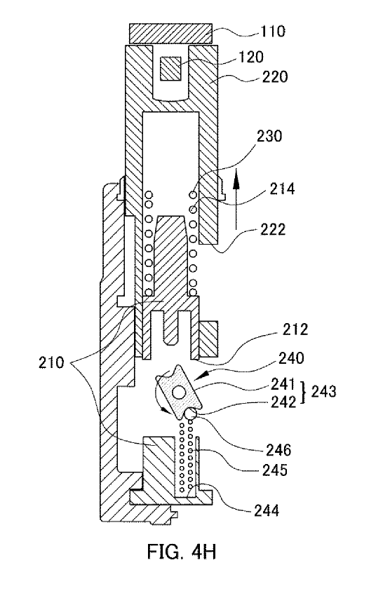

The attached FIG. 3 is a cross-sectional view illustrating a device for opening and closing a push open type fuel door according to the present invention, and FIGS. 4A to 4H are views or cross-sectional views illustrating a flow of opening and closing operations of the device for opening and closing the push open type fuel door according to the present invention.

In FIG. 3, reference numeral 400 indicates a housing. The housing 400 is divided into a vertical chamber 410 and a horizontal chamber 420 that communicate with each other, and an upper portion of the vertical chamber 410 is opened.

A latch assembly 100 and a push button assembly 200, which may open and close a fuel door using a one touch push operation, are mounted in the vertical chamber 410 of the housing 400, and a motor assembly 300, which may lock a push button 220 of the push button assembly 200 and a latch 120 of the latch assembly 100 so that the push button 220 and the latch 120 are not moved when the fuel door is closed, is mounted in the horizontal chamber 420.

The latch assembly 100 comes into direct contact with a rear surface of the fuel door 10, and serves to lock or unlock a striker 110 formed on the rear surface of the fuel door 10. To this end, the latch assembly 100 includes the latch 120 for locking and unlocking the striker 110 formed on the rear surface of the fuel door 10.

In more detail, a first locking groove 122 having an oblique line shape into which the striker 110 is separably inserted and locked, is formed in one surface of the latch 120, a catching projection 124, which is caught by an upper end portion of the vertical chamber 410 of the housing 400, is formed on a lower end portion (a bottom surface) of the other surface of the latch 120.

The lower end portion of the latch 120, which is provided as described above, is hingedly fastened to an upper end portion of the push button 220 of the push button assembly 200 so as to be angularly rotatable, and a return spring 126 is fastened at a point at which the lower end portion of the latch 120 is hingedly fastened so as to serve to provide elastic restoring force and guide the latch 120 always in an unlocking direction (in a direction in which the striker may be separated).

The push button assembly 200 serves to operate the latch 120 of the latch assembly 100 to an unlocked position at which the striker 110 may be separated or operate the latch 120 to a locked position of the striker 110 while being moved upward and downward by force that pushes the fuel door 10.

A fixed tube 210, which is one of the configurations of the push button assembly 200, is fixedly mounted in the vertical chamber 410 of the housing 400. In this case, the fixed tube 210 has a structure in which a first open hole 212 is formed in a lower end portion at one side thereof, and a stepped portion 214 is formed on an outer diameter of a middle portion thereof. In particular, the push button 220 is disposed on an outer diameter portion of the fixed tube 210 so as to be movable upward and downward.

In more detail, as best seen in FIGS. 4A to 4H, the push button 220 has a hollow tube shape, and has a structure in which the latch 120 of the latch assembly 100 is hingedly fastened to an upper end portion thereof, and a second open hole 222, which is matched with the first open hole 212 of the fixed tube 210, is formed in a lower end portion at one side thereof.

The main spring 230 is compressibly disposed between a bottom surface of the push button 220 and the stepped portion 214 of the fixed tube 210 so as to provide elastic restoring force when the push button 220 is moved upward and downward.

In this case, a stopper means 240, which allows the push button 220 to be moved upward and downward when the fuel door 10 is opened, and temporally stops the upward and downward movement of the push button 220 when the fuel door 10 is closed, is mounted in the fixed tube 210.

As best seen in FIGS. 4A to 4H, the stopper means 240 includes a heart cam 243 which is rotatably and hingedly mounted in the fixed tube 210, an auxiliary spring 245 which is inserted into an insertion groove 244 formed in a bottom surface of the fixed tube 210, and a ball 246 which is integrally attached to an upper end of the auxiliary spring 245, and come into close contact with the heart cam 243 while receiving elastic force of the auxiliary spring 245.

In particular, upper and lower surfaces of the heart cam 243 are formed as flat surfaces 241, and recesses 242 are formed in left and right surfaces of the heart cam 243. When the heart cam 243 is horizontally or diagonally disposed or substantially horizontally or diagonally disposed, one end of the heart cam 243 protrudes through the first open hole 212 of the fixed tube 210 so as to be in contact with an upper surface or a lower surface (bottom surface) of the second open hole 222 of the push button 220. When the heart cam 243 is vertically or vertically disposed, the heart cam 243 is positioned inside the first open hole 212 so as not to interfere with the push button 220.

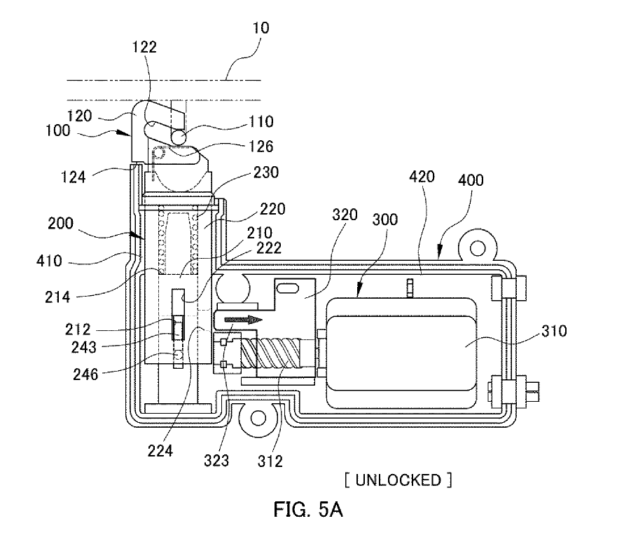

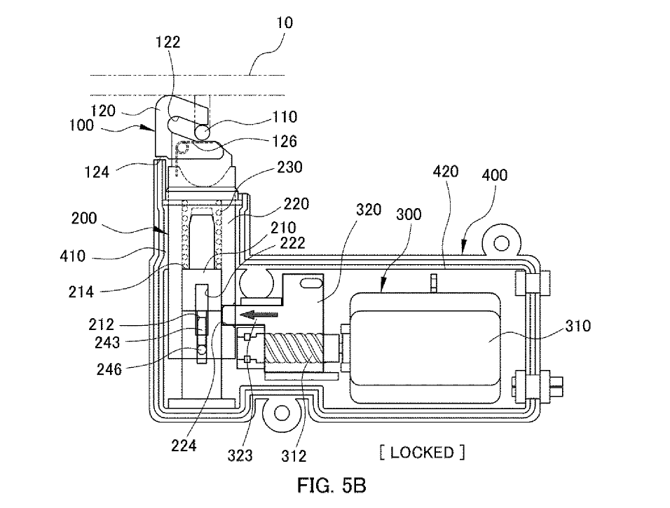

Meanwhile, as best seen in FIGS. 5A ang 5B, when the fuel door 10 is closed, the motor assembly 300 serves to lock and restrict the push button 220 of the push button assembly 200 so that the push button 220 and the latch assembly 100 are not moved.

To this end, the motor assembly 300 includes a motor 310 which is mounted in the horizontal chamber 420 that communicates with the vertical chamber 410 of the housing 400, and a conveying body 320 which is fastened to a screw shaft 312 of the motor 310 so as to be moved forward and rearward.

In this case, a locking pin 323, which is separably inserted into a second locking groove 224 formed in an outer diameter surface of the push button 220 of the push button assembly 200, protrudes on a front end portion of the conveying body 320.

Here, a flow of operations of the device for opening and closing the push open type fuel door of the present invention, which is configured as described above, will be described.

First, as illustrated in FIGS. 4A and 4B, the locking pin 323 of the motor assembly 300 is moved rearward and separated from the second locking groove 224 of the push button 220 in order to open the fuel door.

The heart cam 243 is horizontally or substantially horizontally disposed, and one end portion having the recess 242 protrudes through the first open hole 212 of the fixed tube 210.

A bottom surface at one end of the heart cam 243, which protrudes through the first open hole 212 comes into close contact with the second open hole 222 of the push button 220, and the push button 220 is temporarily stopped by being caught by the heart cam 243.

The catching projection 124 of the latch 120 is caught by a front end portion of the vertical chamber 410 of the housing 400, and restricted so that the latch may not be rotated in a direction in which the striker is opened (counterclockwise direction in FIGS. 4A to 4H) despite elastic restoring force of the return spring 126.

As illustrated in FIGS. 4C and 4D, when a user presses the fuel door 10 in a state in which the fuel door 10 is maintained to be closed (see FIGS. 4A and 4B), the rear surface of the fuel door 10 presses the latch 120, and the striker 110 of the fuel door 10 presses an upper surface of the push button 220.

Consecutively, as illustrated in FIGS. 4C and 4D, the push button 220 is moved downward while compressing the main spring 230 by force by which the user presses the fuel door, and the bottom surface of the second open hole 222 of the push button 220 is spaced apart downward from one end portion of the heart cam 243.

In this case, when the user releases the fuel door 10, that is, when the user release force for pressing the fuel door, the push button 220 is moved upward by elastic restoring force of the main spring 230, as illustrated in FIGS. 4E and 4F, and as the push button 220 is moved upward, the bottom surface of the second open hole 222 of the push button 220 lifts up the bottom surface at one end of the heart cam 243.

Consecutively, the heart cam 243 is rotated in the counterclockwise direction by force by which the bottom surface of the second open hole 222 of the push button 220 is lifted so as to be diagonally disposed, the ball 246 comes into contact with the flat surface 241 of the heart cam 243, and inserted into the recess 242 of the heart cam 243, as illustrated in FIGS. 4G and 4H, and the push button 220 is continuously moved upward.

As the push button 220 is moved upward as described above, the latch 120, which is hingedly fastened to the upper end of the push button 220, and the striker 110, which is locked in the first locking groove 122 of the latch 120, are also moved upward, the fuel door 10, which is formed integrally with the striker 110, is pushed in an opening direction, and as a result, the fuel door is opened.

In this case, as the latch 120 is moved upward, the catching projection 124 of the latch 120 is caught by the front end portion of the vertical chamber 410 of the housing 400, and the restricted state is released.

At the same time, as illustrated in FIGS. 4G and 4H, the latch 120 is rotated in the counterclockwise direction by elastic restoring force of the return spring 126, and the first locking groove 122 of the latch 120 is directed toward the fuel door 10, such that the striker 110 is unlocked to be separated from the first locking groove 122.

After the fuel door is opened as described above, the user opens a cap of the refueling port, and fills a vehicle with fuel.

Meanwhile, when the user presses the outer surface of the fuel door 10 in order to close the fuel door again, the latch 120 and the like in addition to the push button 220 are moved downward together, and consecutively, the lower end of the push button 220 lifts down the one end of the heart cam 243 that is diagonally disposed.

Therefore, the heart cam 243 is instantaneously rotated in a clockwise direction, and the ball 246 is moved out of the recess 242, and comes into contact with the flat surface 241 of the heart cam 243. As illustrated in FIGS. 4A and 4B, the bottom surface at one end of the heart cam 243 comes into close contact with the bottom surface of the second open hole 222 of the push button 220 again, such that the push button 220 is caught by the heart cam 243, and temporarily stopped again.

In this case, when the user gets out of the vehicle, or presses a LOCK button in a remote controller in order to lock or unlock a door of the vehicle so as to drive the vehicle, an ECU sends a locking signal to the motor 310 of the motor assembly 300 by communication.

Consecutively, the motor 310 is operated, and at the same time, the screw shaft 312 is rotated in place in a locking direction, such that the conveying body 320 is moved forward, and the locking pin 323 of the conveying body 320 is inserted into the second locking groove 224 of the push button 220.

Therefore, the push button 220 and the latch assembly 100 are restricted so as not to be moved any more, and the fuel door is locked so that an outsider cannot open the fuel door.

As such, a speed at which the fuel door pops up in an opening direction may be constantly controlled so as to correspond to a speed at which the push button is moved upward and downward, and a pop-up phenomenon in which the fuel door is slightly opened may be prevented by a locking operation of the motor assembly when the fuel door is closed.

For convenience in explanation and accurate definition in the appended claims, the terms “upper” or “lower”, “front” or “rear”, “left” or “right”, “upward” or “downward”, and etc. are used to describe features of the exemplary embodiments with reference to the positions of such features as displayed in the figures.

The foregoing descriptions of specific exemplary embodiments of the present invention have been presented for purposes of illustration and description. They are not intended to be exhaustive or to limit the invention to the precise forms disclosed, and obviously many modifications and variations are possible in light of the above teachings. The exemplary embodiments were chosen and described in order to explain certain principles of the invention and their practical application, to thereby enable others skilled in the art to make and utilize various exemplary embodiments of the present invention, as well as various alternatives and modifications thereof. It is intended that the scope of the invention be defined by the Claims appended hereto and their equivalents.

What is claimed is:

1. A device for opening and closing a push open type fuel door for a vehicle, the device comprising:
a latch assembly which comes into direct contact with a fuel door so as to lock or unlock the fuel door;
a push button assembly which is connected with the latch assembly so as to be operated in conjunction with the latch assembly, and unlocks or locks the latch assembly while being moved upward or downward by pushing the fuel door; and
a motor assembly which locks a push button of the push button assembly so as to restrict movement of the push button and the latch assembly when the fuel door is closed,
wherein the latch assembly, the push button assembly and the motor assembly are modularized and mounted in a single housing.

2. The device of claim 1, wherein the latch assembly includes:
a striker which is formed on a rear surface of the fuel door;
a latch including a first locking groove into which the striker is separably inserted and locked and a catching projection which is caught by an upper end portion of a vertical chamber of the housing, wherein the first locking groove is formed in one surface of the latch, and the catching projection is formed on a lower end portion of another surface of the latch and hingedly fastened to an upper end portion of the push button of the push button assembly; and
a return spring which is fastened to a point at which the latch is hingedly fastened to the push button, and provides elastic restoring force so as to guide the latch in a direction in which the striker is separated.

3. The device of claim 1, wherein the push button assembly includes:
a fixed tube including a first open hole formed in a lower end portion at one side and a stepped portion formed at a middle portion, and fixedly mounted in the vertical chamber of the housing;
the push button having a tube shape and disposed on an outer diameter portion of the fixed tube so as to be movable upward and downward, wherein a latch of the latch assembly is hingedly fastened to an upper end portion of the push button, and the push button has a second open hole formed in a lower end portion at one side of the push button and matched with the first open hole of the fixed tube;
a main spring which is compressibly disposed between a bottom surface of the push button and the stepped portion of the fixed tube; and
a stopper means which is mounted in the fixed tube so as to allow the push button to be moved upward and downward when the fuel door is opened, and temporarily stop the upward and downward movement of the push button when the fuel door is closed.

4. The device of claim 3, wherein the stopper means includes:
a heart cam including flat upper and lower surfaces and recessed left and right surfaces, and hingedly mounted in the fixed tube so as to protrude through the first open hole of the fixed tube when the heart cam is horizontally or diagonally disposed, or to be rotated to be disposed in the first open hole when the heart cam is vertically disposed;
an auxiliary spring which is inserted into an insertion groove formed in a bottom surface of the fixed tube; and
a ball which is integrally attached to an upper end of the auxiliary spring, and comes into close contact with a surface of the heart cam while receiving elastic force of the auxiliary spring.

5. The device of claim 1, wherein the motor assembly includes:
a motor which is mounted in a horizontal chamber that communicates with the vertical chamber of the housing;
a conveying body which is fastened to a screw shaft of the motor so as to be movable forward and rearward; and
a locking pin which protrudes on a front end portion of the conveying body, and is separably inserted into a second locking groove formed in an outer diameter surface of the push button of the push button assembly.
